(19) United States
(12) Patent Application Publication
(10) Pub. No.: US 2025/0300414 A1
(43) Pub. Date: Sep. 25, 2025

(54) SLIDING RING BRUSH HOLDER

(71) Applicant: Venturetec Rotating Systems GmbH, Kaufbeuren (DE)

(72) Inventors: Harry Schilling, Schwabach (DE); Philipp Robi, Jengen (DE); Michael Feneberg, Schwabsoien (DE); Stephan Neubauer, Forchheim (DE)

(21) Appl. No.: 19/087,079

(22) Filed: Mar. 21, 2025

(30) Foreign Application Priority Data
Mar. 21, 2024 (DE) 102024000920.4

(51) Int. Cl. H01R 39/38

(52) U.S. Cl. CPC H01R 39/385; H01R 39/383

(57) ABSTRACT

An apparatus according to the invention comprises a brush holder for receiving a brush for transmitting power between a rotating part and a stationary part of a slip ring having at least a first electrically conductive contacting member and a second electrically insulating guiding member.

### CROSS REFERENCES TO RELATED APPLICATIONS

The following application claims priority under 35 U.S.C. § 119 (a-d) and (f) to German Patent Application Serial No. 102024000920.4 filed Mar. 21, 2024 entitled SLIDING RING BRUSH HOLDER. The above-identified application is incorporated herein by reference in its entirety for all purposes.

### TECHNICAL FIELD

The present disclosure generally relates to a sliding ring brush holder, and more particularly to a sliding ring brush holder for receiving a brush of a slip ring assembly.

### BACKGROUND

DE 10 2013 204 004 A1 describes a holder for brushes in a slip ring assembly using blind rivets. The disadvantage here is the non-detachable connection, which makes it impossible to replace the brushes in the event of a fault.

A holding and contacting device for sliding contacts made of a bent sheet metal part is shown in DE 10 026 176 A1. The bent sheet metal part comprises radii due to the manufacturing process, which can lead to inaccurate guidance of the brushes. In addition, the distance between the electrically conductive bent part and the neighboring slipways is small, which can easily lead to unwanted electrical flashovers.

EP 0 662 736 A1 discloses a brush with a large number of brush wires, in which the individual brush wires are soldered into a sleeve. Due to the large number of brush wires, the production is complex and the brush is prone to failure during use. In particular, individual brush wires may bend or break and make unintentional electrical contact with one of the adjacent slipways.

A brush with individual wires soldered onto the surface of a printed circuit board is disclosed in EP 1 453 155 A2. A simple parallel connection is possible here. However, the high susceptibility to failure due to the mechanically stressed solder joints is disadvantageous.

Furthermore, DE 741 640 shows a holder for the brush of a slip ring for measuring purposes, whereby the brush is held in an insulating holding element, preferably made of glass. This holding element is held in a metal sleeve. The brush is electrically contacted via a wire that is guided through an insulating cap at the end of the holding element opposite the slipway. The metal sleeve, which is not used to guide the brush, extends directly up to the slipway, so that this design is not suitable for the transmission of high voltages with several parallel slipways.

Furthermore, DE 197 55 507 A1 shows a brush holder for mechanically commutated electric motors with a supporting plate and brush guide tubes attached to it. The guide tubes made of a brass sheet are held by a two-part insulating housing. In this case, the insulating housing does not serve to guide the brush and enlarges the structure, so that a dense arrangement of adjacent concentric slipways is not possible.

### SUMMARY

The invention relates to a brush holder or sleeve for a sliding ring brush or sliding ring carbon, referred to below as a “brush” for the sake of simplicity. The brush is used to transmit power and/or electrical signals between parts that rotate against each other. It usually contains a block of silver graphite or copper or similar, which is held by a brush holder or quiver. At least one brush made of an electrically conductive material slides on a slipway made of an electrically conductive material. The galvanic contact between the slipway and the brush transmits electrical current. The entire arrangement is usually referred to as a slip ring.

The invention is based on the task of designing a holder for brushes of a slip ring assembly in such a way that good manufacturability of the brush holder is achieved and, at the same time, reliable electrical insulation from the adjacent slipways is ensured.

This task is solved by a device according to claim 1. Advantageous configurations of the invention are given in the subclaims.

### BRIEF DESCRIPTION OF THE DRAWINGS

The foregoing and other features and advantages of the present disclosure will become apparent to one skilled in the art to which the present disclosure relates upon consideration of the following description of the disclosure with reference to the accompanying drawings, wherein like reference numerals refer to like parts unless described otherwise throughout the drawings and in which:

FIG. 1 shows a completely assembled brush holder without brushes;

FIG. 2 shows a contacting member;

FIG. 3 shows a further embodiment according to the invention in perspective view;

FIG. 4 shows the embodiment of FIG. 3 in plan view;

FIG. 5 shows the embodiment from FIG. 3 in side view;

FIG. 6 shows a view from above of the printed circuit board or substrate used in the embodiment according to FIGS. 3 to 5;

FIG. 7 shows a side view of the brush holder with the brush inserted; and

FIG. 8 shows a view of the brush with an associated spring and wiring.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures generally wherein like numbered features shown therein refer to like elements throughout unless otherwise noted. The present disclosure generally relates to a sliding ring brush holder, and more particularly to a sliding ring brush holder for receiving a brush of a slip ring assembly.

A brush holder according to the invention comprises a conductive contacting member 1 and a non-conductive guiding member 2.

The conductive contacting member 1 is adapted to allow a galvanic connection with the substrate 3 of the brush holder.

The non-conducting guiding member 2 serves, in addition to the contacting member 1, to hold and guide the brush. Since the guiding member 2 is made of an electrically insulating material, the insulating distance between the electrically conducting part of the brush holder and the neighboring slipways of a slipring assembly that do not belong to the brush holder is increased, whereby significantly higher air or insulation distances are achieved. This makes it possible to transmit higher voltages between the brush holder, brush 6 and slipway while the geometries remain the same.

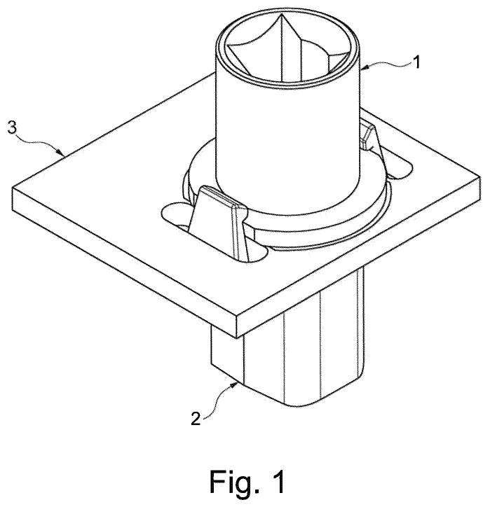

FIG. 1 shows a completely assembled multipart brush holder according to the invention, with no brush 6 inserted yet. The conductive contacting member 1 is pressed into the at least partially conductive substrate 3, here a printed circuit board, and thus provides a galvanic connection. The electrically non-conductive guiding member 2 is connected to the contacting member 1 by means of a form-locking connection. This configuration allows a form-fitting connection to be made simultaneously with the substrate 3 through the form-fitting connection of the contacting member 1 and the guiding member 2.

The brushes 6 are usually elongated carbon or graphite blocks with a rectangular cross-section, the cross-section being chosen so as to enable good electrical contact with the slipway.

The contacting member 1 and the guiding member 2 extend linearly along the longitudinal direction of the brush 6, that is, in the direction in which the brush 6 is pressed against the slipway.

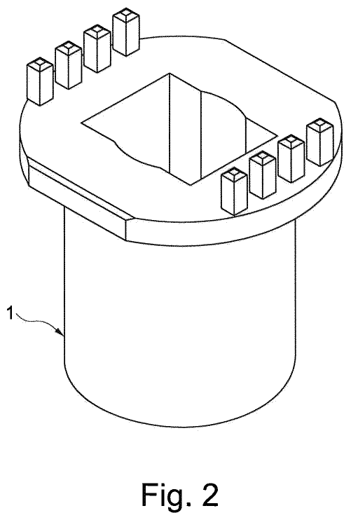

FIG. 2 shows the contacting member 1, which is designed such that it is suitable for press-in technology in the substrate 3.

In the brush holder according to the invention, the electrical contacting is realized by means of the conductive contacting member 1, which is preferably arranged on a side of the substrate 3 facing away from the slipway.

The insulating guiding member 2 holds and guides the brush 6 on the side of the substrate 3 facing the slipway.

In many applications, it is necessary to arrange several slipways concentrically to each other in order to transmit different signals or current phases. Since the available space is limited, it is desirable to keep the distance between the concentric slipways as small as possible.

Since the brushes 6 utilize as much of the width of the slipway as possible for reliable transmission, there is a risk of arc-over between the edge of the brush holder and an adjacent slipway. To prevent this, the invention proposes holding the brush 6 on the side of the substrate 3 facing the slipway in an insulating guiding member 2.

On the other hand, when a larger electrical power is transmitted, it is no longer possible to divert the current only via a spring 7, which biases the brush 6 in the brush holder against the slipway. Therefore, according to the invention, the contacting member 1 is conductively configured. This contact element holds and guides the brush 6 on the side of the substrate 3 facing away from the slipway. Since the brushes 6 do not abrade on this side of the substrate 3, the risk of a arc-over is significantly reduced. Furthermore, the brush holders can be distributed along the circumference of the slipways, so that a flashover between the contacting members 1 of adjacent slipways can be prevented.

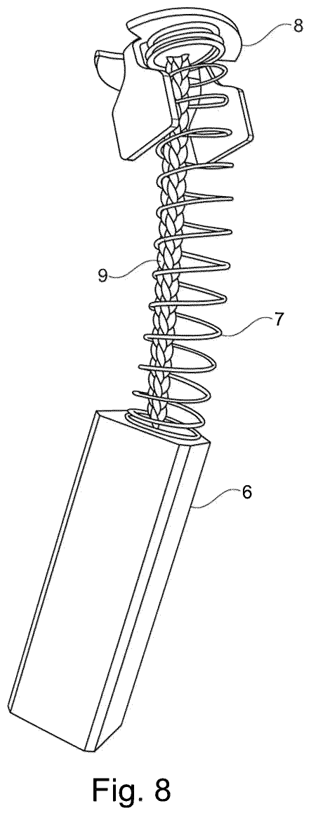

As shown in FIG. 8, a cable 9, preferably a copper cable, is stamped into the brushes 6, for example carbon brushes, as standard, a spring 7 is threaded on and then a contact plate 8 is soldered on. This contact plate 8 provides the electrical connection between the carbon 6 and the contacting member 1. When such a complete brush block is installed in the system, the brush 6 is inserted into the contacting member 1 and secured with a screw cap 10, as can be seen in FIG. 7. When servicing is required, to replace a worn brush 6, the screw cap 10 is loosened again, the worn brush 6 together with the spring 7, copper cable 9 and contact plate 8 are removed and replaced with new ones. The main purpose of the spring 7 is to press the brush 6 onto the slipway, while the current is conducted via the copper cable 9 and the contacting member 1.

As can be seen in FIG. 2, the insulating guiding member 2 is connected to the contacting member 1 by means of spring clips through the substrate 3, so that they are aligned linearly in the longitudinal direction of the brush 6.

Preferably, the contacting member 1 is connected to the substrate 3 in an electrically conductive manner, as can be seen from the contacting pins indicated in FIG. 2. These can make contact with corresponding conductor tracks on the substrate 3.

Since, according to the invention, the inner clearances of both the contacting member 1 and the guiding member 2 are identical, aligned with each other and adapted to the peripheral contour of the brush 6, thereby defining a receiving space for the brush 6, the brush 6 is guided during operation by both the guiding member 2 and the contacting member 1. The spring 7 shown in FIG. 8 presses the brush 6 against the slipway. During operation, the brush 6 can move along its longitudinal direction towards the slipway in order to compensate for wear of the brush 6.

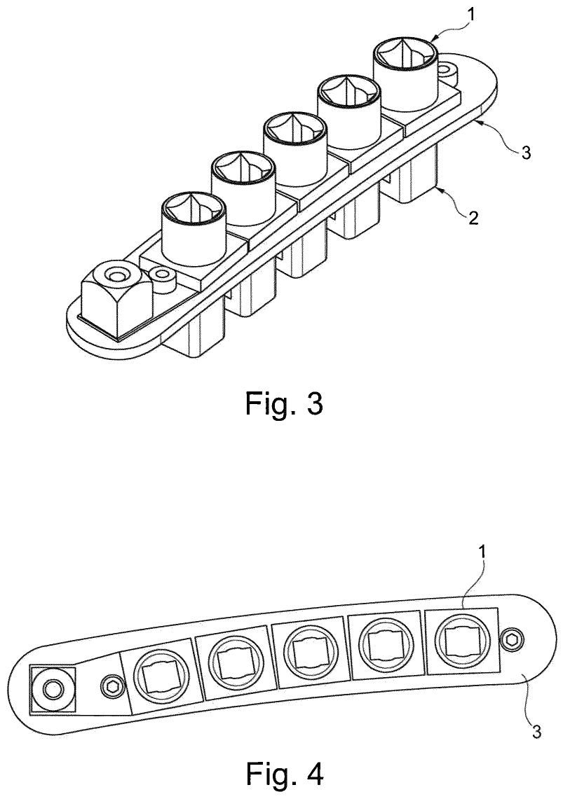

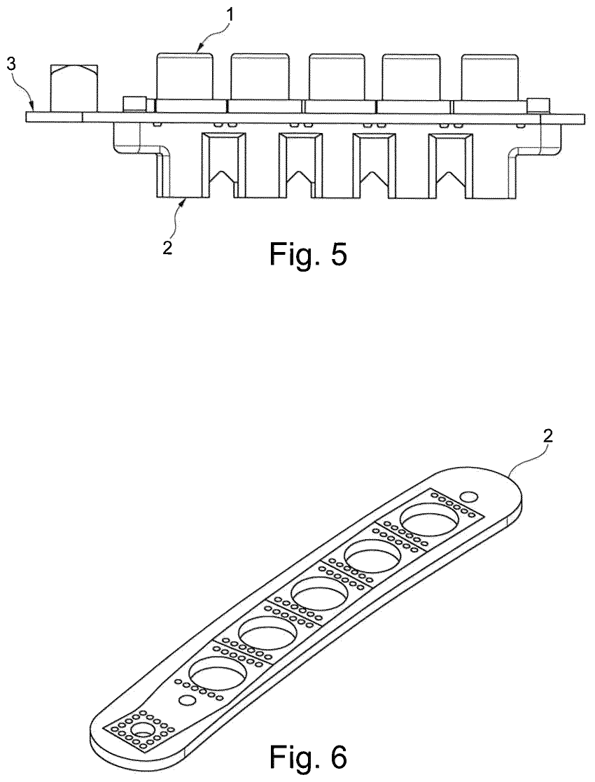

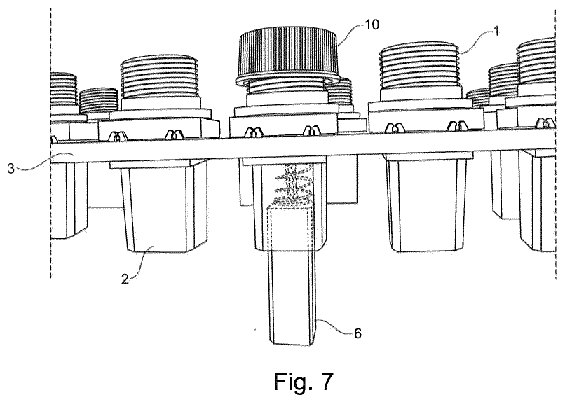

FIGS. 3 to 6 show a further embodiment of the invention.

For better and secure contacting of the slipway, in this embodiment, several brushes 6—five in the example shown—are arranged so that they can be brought into contact with a slipway. In this case, it is preferable to design the guiding members 2 in one piece for all or several brushes 6 of a slipway, which facilitates assembly. Furthermore, in this case it is preferable to connect the guiding member 2 to the substrate 3 using screws 4 that engage through the substrate 3 into the threaded holes of the common guiding member 2.

The common guiding member 2 of the plurality of brushes 6 can be easily manufactured by 3D printing in the case of smaller series, so that the brushes 6 are arranged on a circle segment corresponding to the radius of the slipway. In the case of larger series, the guiding member 2 can also be manufactured in the classical manner by pressure die casting or injection molding.

To improve the stability of the guiding member 2, ribs 5 are formed between the individual guiding sections of the brushes 6. This makes it possible to keep the wall thickness of the guiding sections themselves low, which contributes to a compact design of the guiding member 2. Furthermore, the ribs 5 preferably comprise a recess at the end facing the slipway, so that they do not come into contact with the slipway, even if it is uneven or dirty, in order to avoid damage.

As a preferred alternative, it is provided that on the side of each contacting member 1 facing away from the slipway, there is an opening through which the brush 6 can be replaced, as described above. This opening is closed during operation by means of the cap 10, which, together with the contact plate 8, serves as an abutment for the spring 7 that presses the brush 6 against the slipway.

However, the invention is not limited to this. It is also possible to separate the contacting member 1 and the guiding member 2 from each other at a different location and to use the brush block from FIG. 8.

Various options are available for connecting the contacting member 1 and the guiding member 2: they can be connected by means of a form fit, force fit, material fit or adhesive.

Alternatively, they can be fixed by means of rivets, snap rings or snap-on connections.

In the preferred embodiment, FIGS. 3 to 6, the elements are connected to one another by means of a screw thread.

In a further preferred embodiment, the contacting member 1 is electrically conductively connected to the substrate 3, either by means of press-in technology or a solder connection.

In a further embodiment, not shown, the guiding members 2 of adjacent slipways can be made in one piece, so that a plurality of guiding members 2 can be securely attached to the desired positions with a few screws.

For example, 5 brushes 6 can be provided for each slipway, and 25 brushes 6 can be combined as an array for the contact of 5 slipways for 3 phases of the current, for an grounding connection and a neutral conductor. This array can be extended for further slipways, for example for the transmission of control or data signals, if these are also to be transmitted by sliding contact.

In this case, it is important to ensure that a sufficient distance remains between the contacting members 1 of neighboring slipways to prevent electrical flashovers, for example by leaving an intermediate distance between the contacting members 1 that access a common slipway, and by arranging the contacting member 1 of the neighboring slipway adjacent to this intermediate distance, i.e. in a gap.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 10%, in another possible embodiment within 5%, in another possible embodiment within 1%, and in another possible embodiment within 0.5%.

The term “coupled” as used herein is defined as connected or in contact either temporarily or permanently, although not necessarily directly and not necessarily mechanically. A device or structure that is “configured” in a certain way is configured in at least that way but may also be configured in ways that are not listed. The term “integral” as used herein unless defined otherwise means configured in such a way that separation would require destruction to the parts or the assembly of the parts.

It should be appreciated by those of ordinary skill in the art after having the opportunity of reviewing the drawings and/or specification of the present disclosure that it may include one or more embodiments, e.g., E₁, E₂, . . . . Eₙ and that each embodiment E may have multiple parts A₁, B₁, C₁ . . . . Zₙ that (without further description) could be combined with other embodiments Eₙ, embodiment parts e.g. A₁, C₁, or lack of parts originally associated with one or all embodiments Eₙ, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes after having the benefit of reviewing the subject disclosure and accompanying drawings.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A brush holder for receiving a brush of a slip ring assembly, the brush holder comprising:
at least one guiding member; and
one contacting member, wherein the contacting member is electrically conductive and the guiding member is electrically insulative, and wherein both members are configured to hold and guide a common brush.

2. The brush holder according to claim 1, wherein the contacting member and the guiding member are connected to each other by one from the group consisting of form fit, force fit, material fit and an adhesive.

3. The brush holder according to claim 1, wherein the contacting member and the guiding member are connected to each other by one from the group consisting of rivets, snap rings and snap connections.

4. The brush holder according to claim 1, wherein the contacting member and the guiding member are connected to each other by a thread.

5. The brush holder according to claim 1, wherein the contacting member is electrically conductively connected to a substrate by one from the group of press-in technique and a solder connection.

6. The brush holder according to claim 1, wherein the contacting member and the guiding member comprise a receiving space for receiving the brush, which corresponds to the shape of the brush and can thereby hold and guide it.

7. The brush holder according to claim 1, wherein said guiding member is formed in one piece.

8. The brush holder according to claim 7, wherein said guiding member is arranged along a segment of a circle whose radius corresponds to that of a slipway to be contacted.

9. The brush holder according to claim 8, wherein said guiding member is arranged to contact a plurality of concentrically arranged slipways.

10. The brush holder according to claim 9, wherein said guiding member is interconnected by ribs.

11. A brush holder for receiving a brush of a slip ring assembly, the brush holder comprising:
at least one guiding member;
one contacting member, wherein the contacting member is electrically conductive and the guiding member is electrically insulative, wherein both members are configured to hold and guide a common brush, and wherein the contacting member and the guiding member are connected to each other by a fit connection.

12. The brush holder according to claim 11, wherein the fit connection is an adhesive connection.

13. The brush holder according to claim 11, wherein the contacting member and the guiding member are connected to each other by one from the group consisting of rivets, snap rings and snap connections.

14. The brush holder according to claim 11, wherein the contacting member and the guiding member are connected to each other by a thread.

15. The brush holder according to claim 11, wherein the contacting member is electrically conductively connected to a substrate by one from the group of press-in technique and a solder connection.

16. The brush holder according to claim 11, wherein the contacting member and the guiding member comprise a receiving space for receiving the brush, which corresponds to the shape of the brush and can thereby hold and guide it.

17. The brush holder according to claim 11, wherein said guiding member is formed in one piece.

18. The brush holder according to claim 17, wherein said guiding member is arranged along a segment of a circle whose radius corresponds to that of a slipway to be contacted.

19. The brush holder according to claim 18, wherein said guiding member is arranged to contact a plurality of concentrically arranged slipways.

20. A brush holder for receiving a brush of a slip ring assembly, the brush holder comprising:
at least one guiding member; and
one contacting member, wherein the contacting member is electrically conductive and the guiding member is electrically insulative, wherein both members are configured to hold and guide a common brush, and wherein the contacting member and the guiding member are connected to each other by a thread.
